(19) United States
(12) Patent Application Publication
(10) Pub. No.: US 2002/0090861 A1
(43) Pub. Date: Jul. 11, 2002

(54) Ethernet plug connection having additional contacts for feeding in a voltage supply

(76) Inventors: Matthias Kunick, Schwabach (DE); Ralf Schweigert, Adelsdorf (DE)

Correspondence Address: BAKER & BOTTS, 30 ROCKEFELLER PLAZA, NEW YORK, NY, 10112

(21) Appl. No.: 10/023,035

(22) Filed: Oct. 30, 2001

(30) Foreign Application Priority Data
Oct. 30, 2000 (DE) 100 538 43.6

(51) Int. Cl. H01R 24/00

(52) U.S. Cl. 439/676

(57) ABSTRACT

To make it possible to use Ethernet technology in the field of industrial automation, the present invention is a plug connection based on industrial standard RJ45 which permits a supply of voltage to connected sensors or actuators, etc. Contacts (K1, K2) for feeding in a voltage supply are provided as an integral part of the plug connection. On the socket side (B), an RJ45 standard socket is extended by an insulating body (I) which has two contact areas. The connector side (S) is designed such that further use can be made of RJ45 technology in terms of crimpability, matching to the characteristic impedance, etc., by additionally mounting two corresponding contact elements—e.g. contact springs—which make contact with the socket side (B).

### FIELD OF THE INVENTION

The invention relates to an Ethernet plug connection having additional contacts for feeding in a voltage supply using the standard Ethernet plug system RJ45 and keeping the standard connector assignment provided therein.

### BACKGROUND OF THE INVENTION

Recently, efforts have been made to develop Ethernet components which are suitable for industry. Specifically, attempts have been made to use the technology from office communication systems, which is widespread, in the field of industrial automation. Reasons for doing this are that office communication technology is highly available and relatively low in cost.

Ethernet is a standard for local area networks LAN of workplace computers which is based on bus or star topology. Data are transmitted in “datagrams” having lengths of flexible definition. In the basic version, 10 Mbit/s are transmitted. For Ethernet to be implemented in industry requires, among other things, components which are suitable for industry, such as connectors, lines, etc. It is naturally expedient in this context if, as far as possible, standards which already exist can be used.

Inexpensive plug connections suitable for industry can be achieved only by means of large-scale production. For this reason, it is almost indispensable to use standards which have already been set. For Ethernet, the RJ45 connector has become established as the standard. The specification for the connection technology comprising socket and RJ45 connector is based on the standard IEC 603-7. The abbreviation RJ stands for “Registered Jack”, where jack can be referred to as connector. Such plug connections are also referred to as a “Western connectors” and comprise a series of connectors which were developed in the USA and were initially used only for connecting telephones.

Besides the 4-terminal variants RJ 11 and RJ 14, RJ 45 is the American technical designation for the 8-terminal Western connector. In Germany, this connector is predominantly used for connecting ISDN terminals to the S0 bus and in the LAN field for Ethernet or ATM and for hubs. Advantages of such an RJ45 connector are as follows:

very inexpensive plug connection;

very simple to prepare;

a crimping tool is universally obtainable;

optimum matching to the required characteristic impedance; and compactness.

If Ethernet technology is to be used universally in industry in the future, and if sensors and actuators are also to be equipped with this communication interface, then it is absolutely essential for the connector technology to be extended/developed further. In this context, problems that may arise are:

the type of protection which can be achieved;

the necessary robustness in terms of mechanical vibration and shock loading; and

supplying sensors and actuators with a suitable supply voltage.

One object of the present invention is based is that of providing an inexpensive solution to supplying sensors and actuators with a suitable supply voltage. However, no known solutions exist for doing this on an RJ45 connector. Possible solutions are discussed below.

Ethernet physics normally require only 4 signals. However, as mentioned, the RJ45 connector is an 8-terminal design. This means that it would be possible to use the connector's 4 pins which are still free for the voltage supply. However, such a solution has the drawback that the conductor cross section available for the supply voltage is restricted to a maximum of 0.18 mm², since larger line cross sections cannot be “crimped” in the case of the RJ45 connector. The expression “crimped” is understood to mean the connection of lines to respectively associated contact elements, which is normally accomplished by pinching. Special tools, “crimping tools”, exist for these standard production operations. These tools and the physical shape of the contact elements mean that only lines having a maximum permissible line cross section can be processed. Further, standard Ethernet lines are likewise of an 8-conductor design. This means that such a solution carries a risk of connected Ethernet components being destroyed when a voltage is applied to 2 or possibly even to all 4 free lines or pins. For reasons of electromagnetic compatibility EMC, the voltage supply for the communication channel carrying the actual data transmitted by Ethernet needs to be of shielded design. This presents enormous design problems in the connector region. Moreover, since Ethernet is currently being extended from the basic bandwidth 10 Mbit/s and the Fast Ethernet variant using 100 Mbit/s to 1000 Mbit/s, RJ45-based solutions will require all 8 conductors/pins in future. That is to say that the outlined solution could not be used where high data rates are required.

A solution might be found in another connector technology which could reduce the risk of other Ethernet components being confused and hence destroyed as a result of the plug connection's “changed appearance.” However, here the drawback is that it is not possible to use standard components with the advantage of large-scale production and the associated price advantage.

### SUMMARY OF THE INVENTION

The present invention is therefore based on the object of overcoming the aforementioned problems particularly on the basis of the RJ45 connector. This object is achieved by means of a plug connection for communication systems using Ethernet physics by providing additional contacts for feeding in a voltage supply as an integral part of the plug connection. For example, in an associated socket, particularly a standard socket for an Ethernet plug system based on the RJ45 standard, the object of the present invention is realized by surrounding the socket with an insulating material body which has at least two mutually independent contact elements for feeding in a voltage supply. This can be achieved simply by virtue of the insulating material body being used to hold the socket on the basis of the matching shapes. This also makes it possible for the contact elements of the insulating material body to be electrically coupled to a printed circuit board, carrying a supply voltage, using push-through technology or using SMD technology. It has been found to be preferred if a socket contact assignment for the Ethernet communication channel corresponds to the Ethernet standard.

To satisfy the EMC requirements, it is advisable for the Ethernet communication channel of the socket to be electrically shielded from the contact elements of the insulating material body for the voltage supply. This can be achieved particularly advantageously and easily if the socket is electrically shielded from the insulating material body.

Alternatively, the object of the present invention may be achieved in connection with an appropriate connector, particularly a standard connector for an Ethernet plug system based on the RJ45 standard. In this application, the connector should comprise an insulating material body which has at least two mutually independent contact elements for feeding in a voltage supply. A particularly simple design can be achieved if the insulating material body with the contact elements for feeding in a voltage supply is arranged at the cable end of the connector.

In this embodiment of the invention, it has been found to be beneficial if a connector contact assignment for the Ethernet communication channel corresponds to the Ethernet standard. Further, to satisfy the EMC requirements, it is also advisable for the connector to have the Ethernet communication channel of the connector electrically shielded from the contact elements of the insulating material body for the voltage supply. It has been found to be preferred if the connector has a cable which is routed through the insulating material body and comprises lines for the Ethernet communication channel and also voltage supply lines associated with the contact elements, with the lines for the Ethernet communication channel and the voltage supply lines being electrically shielded from one another.

For a plug connection for communication systems using Ethernet physics which is based on the aforesaid socket and connector, the socket and the connector are matched to one another such that, when the connector and the socket are in the connected state, the respective contact elements for feeding in a voltage supply are electrically connected to one another and said contact elements are arranged such that no electrical interference arises between the voltage supply and the contact elements of the Ethernet communication channel, or any mutual electrical influencing which is permissible for Ethernet physics is not exceeded. In this regard, it has been found to be preferred if the contact elements of the socket are in the form of contact areas, and the contact elements of the connector are in the form of contact springs, or vice versa. An embodiment in which the contact elements of the socket are in the form of contact pins, and the contact elements of the connector are in the form of contact sockets, or vice versa, has also been found to be useful.

### BRIEF DESCRIPTION OF THE DRAWINGS

Further advantages and benefits of the present invention are disclosed below in connection with schematic illustrations of a plurality of embodiments of the inventive plug connection for communication systems using Ethernet physics, in which:

FIG. 1a shows a socket from an oblique view and a front view;

FIG. 1b shows another socket from an oblique view and a front view;

FIG. 2a shows a connector, corresponding to the socket shown in FIG. 1a, from an oblique view, a front view and a side view; and

FIG. 2b shows a connector, corresponding to the socket shown in FIG. 1b, from an oblique view, a front view and a side view.

Other advantages and details of an embodiment will be apparent from the description of the exemplary embodiment below and in conjunction with the above Figures. In this case, elements having the same functionality are identified by the same reference symbols but do not necessarily represent the same elements.

### DETAILED DESCRIPTION OF THE INVENTION

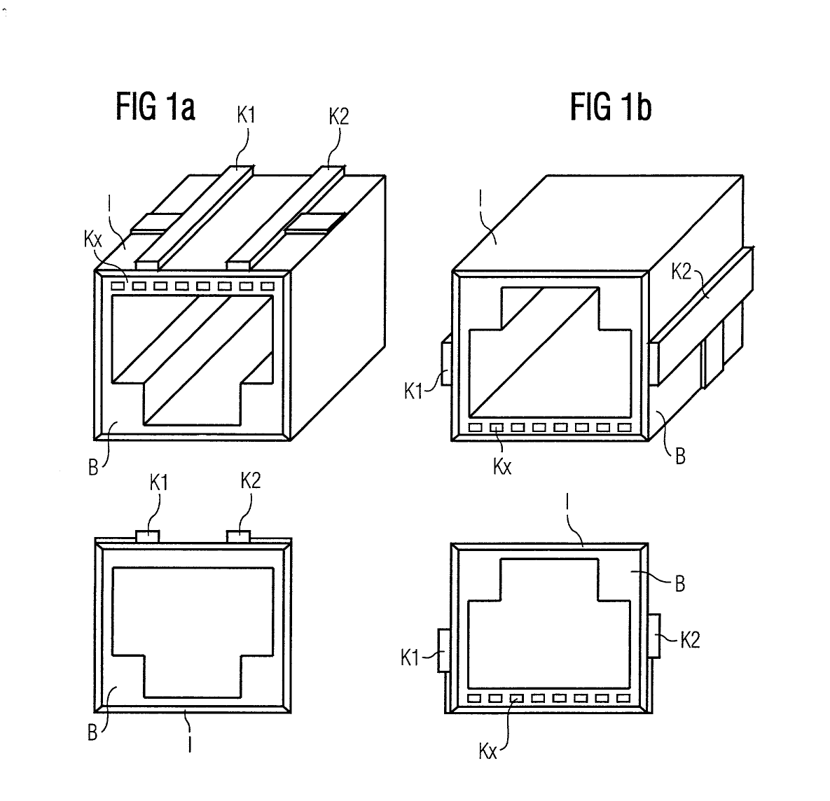

FIGS. 1a and 1b illustrate two possible embodiments of socket B. On the socket side B of a plug connection for communication systems based on Ethernet physics, an RJ45 standard socket is extended by an insulating body I having two contact areas K1, K2. The insulating material body I is preferably designed such that it is used to hold the RJ45 standard socket on the basis of the matching shapes.

In the embodiment shown in FIG. 1a, the two contact elements K1 and K2 are arranged in the form of contact areas on the outer top side of the insulating material body I, and run in the form of contact rails in the longitudinal direction of the socket, parallel to the socket opening. The socket has contact areas Kx for connecting the socket to an assembly or printed circuit board used for making contact between an RJ45 standard connector having 8 pins and the assembly. Contact elements Kx are used to produce the Ethernet communication channel, the connector and socket assignments preferably corresponding to the standard assignment for compatibility reasons. The other contact areas K1, K2 are used for feeding in a supply voltage.

FIG. 1b shows an alternative embodiment of the socket B with an identical insulating material body I, but in which one contact area K1 is mounted on one of the lateral faces of the insulating material body, and the second contact area K2 is mounted on the opposite lateral face.

The contact areas can be coupled to a printed circuit board on which the socket is mounted using either push-through technology or SMD technology. The insulating material body I including the contact areas K1, K2 is preferably a single part which “engages” over the standard socket and can thus be designed such that it can be preassembled, which means that no additional fitting operation is necessary during manufacture. Additional advantages include:

standard sockets can be used;

the voltage supply is routed to the outside of the shielded standard socket which permits continuous shielding between voltage supply and Ethernet communication channel up to the printed circuit board;

there is no problem with protection against incorrect plugging and with destruction of other Ethernet components, because no voltage supply is applied in the standard socket; and

all 8 conductors/pins of the RJ45 standard can be used for Ethernet, which means that the aforementioned extension to 1000 Mbit/s also becomes possible.

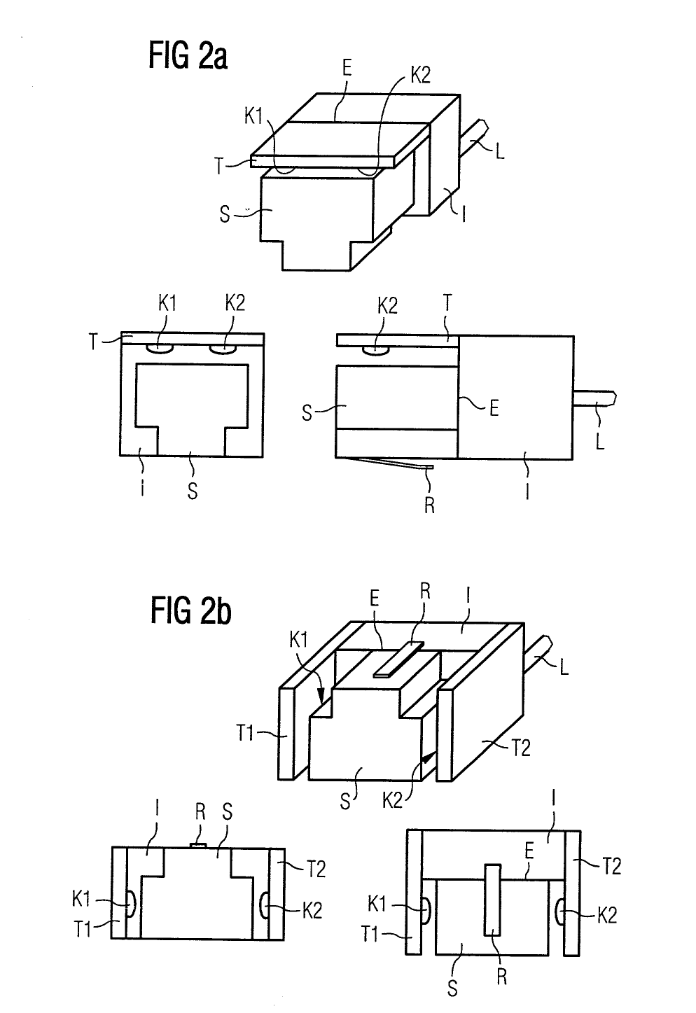

The connector element of the present invention is constructed so that further use can be made of RJ45 technology in terms of crimpability, matching to the characteristic impedance, etc. FIGS. 2a and 2b show the connectors associated with the above-described sockets. The novel connector S shown in FIG. 2a is matched to the socket B shown in FIG. 1a. To make contact with the contact areas of the socket B, the connector S has corresponding contact elements K1 and K2 in the form of contact springs. These are mounted on a support plate T made of insulating material.

The support plate T is mounted on an insulating material body I fitted on the cable end E of the standard connector element. A connecting cable L for the connector S can be routed through the insulating material body. The connector element has a latching hook R known on the basis of RJ45 on its underside and carries the contacts for the Ethernet communication channel. The support plate T is mounted on the insulating material body I such that the support plate T is situated above the connector element, and the side of the support plate T with the contact elements K1, K2 is directed into the interspace between connector element and support plate T. The contact elements K1, K2 are arranged at the same distance as those of the corresponding socket B, which means that the respective contact elements K1, K2 make contact with one another when the connector S is inserted into the associated socket B. In this context, the support plate T can be designed such that it has a slight elastic prestressing in the direction of the connector element and ensures that the contact springs exert sufficient pressure on the respective contact areas. The design may be application-specific in this context and can be optimized for the respective requirements.

In a similar manner, FIG. 2b shows a connector S which matches the socket in FIG. 1b. For the contact areas arranged on the two lateral faces of the insulating material body of the socket B, the connector S shown in FIG. 2b has two support plates T1, T2, each of which has a contact spring element K1 or K2. These elements are mounted on the insulating material body I, added to the RJ45 standard connector element, on two opposite sides such that each contact spring K1 and K2 is situated on one of the two sides of the standard connector element and projects into the respective interspace between connector element and support plate T1 or T2. For the design of the connector S and particularly for each support plate, the comments made above with regard to FIG. 2a apply accordingly.

The illustrations of the present invention are only exemplary and are not intended to limit the scope of the invention. Hence, the contact elements K1 and K2 do not need to be in the form of contact area and contact spring, but may also be in the form of pin and socket or the like. A person skilled in the art may additionally realize other embodiments for implementing the present invention.

Nonetheless, an important feature of the present invention is that the voltage supply is routed externally, and hence standard components can be used and all the advantages of the RJ45 connector can be used.

We claim:

1. A plug connection for communication systems using Ethernet physics and standards, comprising contacts for feeding-in a voltage supply wherein the contacts are provided as an integral part of the plug connection.

2. A socket for a plug connection according to claim 1, comprising an insulating material body which surrounds the socket, and which has at least two contact elements for feeding-in a voltage supply.

3. The socket according to claim 2 for an RJ45 Ethernet plug, wherein the insulating material body forms a housing for the socket, and the socket has an exterior shape which matches the insulating body's interior shape.

4. The socket according to claim 3, wherein the contact elements are electrically coupled to a printed circuit board, carrying a supply voltage.

5. The socket according to claim 3, further comprising a socket contact assignment for an Ethernet standard communication channel.

6. The socket according to claim 5, wherein the Ethernet communication channel is electrically shielded from the contact elements of the insulating material body.

7. The socket according to claim 6, wherein the socket is electrically shielded from the insulating material body.

8. An RJ45 connector for a plug connection for connecting communication systems using Ethernet physics and standards, said connector further comprising an insulating material body which has at least two contact elements for feeding-in a voltage supply.

9. The connector according to claim 8, further comprising a cable having a cable end, and wherein the insulating material body is arranged at the cable end.

10. The connector according to claim 8, further comprising a connector contact assignment for an Ethernet standard communication channel.

11. The connector according to claim 10, wherein the Ethernet communication channel is electrically shielded from the contact elements of the insulating material body.

12. The connector according to claim 9, wherein the connector cable is routed through the insulating material body and comprises lines for an Ethernet communication channel and voltage supply lines for the contact elements, said lines are being electrically shielded from one another.

13. A plug connection according to claim 1, further comprising a socket having contact elements for feeding-in a voltage supply and a connector having contact elements for feeding-in a voltage supply and wherein when the connector and the socket are connected, their respective contact elements are electrically connected to one another and said contact elements are arranged so that no electrical interference arises between the voltage supply and contact elements of an Ethernet communication channel.

14. The plug connection according to claim 13, wherein the contact elements of the socket are in the form of contact areas, and the contact elements of the connector are in the form of contact springs.

15. The plug connection according to claim 13, wherein the contact elements of the socket are in the form of contact pins, and the contact elements of the connector are in the form of contact sockets.

16. A plug connection according to claim 1, wherein any mutual electrical influencing which is permissible for Ethernet physics is not exceeded.
